(19) United States
(12) Patent Application Publication
(10) Pub. No.: US 2003/0025006 A1
(43) Pub. Date: Feb. 6, 2003

(54) Impinging sheet atomizer nozzle

(76) Inventors: William T. Scarbrough, Rochester, NY (US); Gail E. Geiger, Caledonia, NY (US); Daniel Pobuda, Fairport, NY (US)

Correspondence Address: Delphi Technologies, Inc., P.O. Box 5052, Mail Code 480414420, Troy, MI, 48007, US

(21) Appl. No.: 09/921,670

(22) Filed: Aug. 3, 2001

(51) Int. Cl. F02M 61/00; B05B 7/04; F02M 51/00; F02M 55/00; F02M 47/00; F02M 59/00; F02M 63/00; B05B 1/30

(52) U.S. Cl. 239/533.12; 239/533.3; 239/585.5; 239/433

(57) ABSTRACT

A pressure atomizer includes a body having a central axis, and defining a chamber. The body further defines a connecting passage that fluidly connects the chamber to an exterior of the body. The connecting passage has an inside surface. A substantially cylindrical separator collar is disposed concentrically within the connecting passage, and includes an inside surface and an outside surface. At least a portion of the outside surface is disposed a predetermined distance from the inside surface of the connecting passage to thereby define an outer fluid passageway. The outer fluid passageway extends from the chamber to a first exit point. A pintle is disposed substantially concentrically within the separator collar. The pintle includes an outside surface that is disposed a predetermined distance from the inside surface of the separator collar to thereby define an inner fluid passageway. The inner fluid passageway extends from the chamber to a second exit point.

### TECHNICAL FIELD

The present invention relates generally to nozzles for the atomization of fluids and, more particularly, to such nozzles used for atomizing fuel for injection into an internal combustion engine.

### BACKGROUND OF THE INVENTION

Generally, direct injection (DI) is the spraying of fuel under pressure through the nozzle of a fuel injector and into the combustion chamber of an internal combustion engine. By spraying a very precise amount of fuel in the form of atomized fuel particles into the combustion chamber, DI realizes a substantial reduction in undesirable emissions and an increase in fuel economy. Generally, the requirements for an efficient DI system are small fuel particle size, control of spray penetration, and control of the dispersion of the fuel particles within the combustion chamber.

The extent to which the injected fuel is atomized, as measured by the fuel particle size, is a critical factor in the efficiency of DI systems. Incompletely atomized fuel has large particle size whereas fuel that is substantially completely atomized has small particle size. Large fuel particles in DI systems create uncontrolled localized high concentrations of fuel within the combustion chamber. The large fuel particles evaporate into the combustion charge relatively slowly. Thus, an incomplete combustion process may result. In contrast, smaller fuel particles evaporate into the combustion charge relatively quickly, thereby promoting a mixture of fuel and air within the combustion chamber that promotes a more complete combustion process. The more complete combustion process, in turn, reduces the level of undesirable emissions and increases fuel economy.

Conventional atomizer nozzles typically contain a plurality of internal fluid-atomizing features, such as orifices and plates, which atomize the fluid. The atomized fluid then exits the nozzle through a final exit orifice. Incorporating a plurality of fluid-atomizing features within a nozzle makes the design, manufacture and assembly of such nozzles relatively complex. Further, incorporating a plurality of atomizing features within a nozzle can increase size and weight of the nozzle.

Conventional DI systems atomize fuel by flowing the fuel under high pressure through the nozzle of a fuel injector. As the pressure under which the fluid is pushed through the nozzle increases, the degree to which the fuel is atomized also increases and fuel particle size is reduced. In order to achieve sufficiently small fuel particle size, conventional DI systems require the fuel to flow through the nozzle under relatively high pressure, typically from approximately 10 to 12 MPa. Although such high pressures may achieve adequate fuel atomization, the injected fuel has a correspondingly high spray front velocity, such as, for example, above forty meters per second.

Such high spray front velocities make it difficult to achieve desirable levels of spray penetration and spray dispersion. Thus, fuel is likely to be impinged upon the combustion chamber wall and/or highly and uncontrollably dispersed within the combustion chamber. In fact, due to the high operating pressures required to adequately atomize fuel and the resulting high spray front velocities, many conventional DI systems must impinge fuel off the combustion chamber wall and/or the piston to create a stratified combustion charge. Furthermore, conventional DI systems typically require a high-pressure fuel pump and high-pressure fuel rails, which add complexity, weight and cost to the DI system. Moreover, the nozzle and the atomizing features thereof must be machined to exacting tolerances, making the nozzle difficult to manufacture, sensitive to manufacturing variations, and costly to produce.

Therefore, what is needed in the art is an atomizer nozzle that efficiently atomizes fuel under substantially lower pressure than conventional fuel atomizer nozzles to thereby eliminate the need for high-pressure components, such as a high-pressure fuel pump and rails.

Furthermore, what is needed in the art is an atomizer nozzle that does not require a plurality of internal atomizing features in order to atomize fluid.

### SUMMARY OF THE INVENTION

The present invention provides an atomizer nozzle.

The invention comprises, in one form thereof, a body having a central axis, and defining a chamber. The body further defines a connecting passage that fluidly connects the chamber to an exterior of the body. The connecting passage has an inside surface. A substantially cylindrical separator collar is disposed concentrically within the connecting passage, and includes an inside surface and an outside surface. At least a portion of the outside surface is disposed a predetermined distance from the inside surface of the connecting passage to thereby define an outer fluid passageway. The outer fluid passageway extends from the chamber to a first exit point. A pintle is disposed substantially concentrically within the separator collar. The pintle includes an outside surface that is disposed a predetermined distance from the inside surface of the separator collar to thereby define an inner fluid passageway. The inner fluid passageway extends from the chamber to a second exit point.

An advantage of the present invention is that fuel is substantially completely atomized in an efficient manner and at substantially lower pressure than in conventional high-pressure atomizer nozzles.

Another advantage of the present invention is that the need for high-pressure components, such as a high-pressure fuel pump, are eliminated.

A further advantage of the present invention is that atomization of the fluid occurs external to the nozzle through the impingement of perpendicular sheets of fluid upon each other.

Yet another advantage of the present invention is that by externally atomizing the fluid, the nozzle does not require internal atomization features and is thus less complex to manufacture.

### BRIEF DESCRIPTION OF THE DRAWINGS

The above-mentioned and other features and advantages of this invention, and the manner of attaining them, will become apparent and be better understood by reference to the following description of one embodiment of the invention in conjunction with the accompanying drawings, wherein:

FIG. 1 is a longitudinally-sectioned view of one embodiment of an atomizer of the present invention; and

FIG. 2 is a longitudinally-sectioned view of one embodiment of a fuel injector incorporating the pressure atomizer of FIG. 1;

Corresponding reference characters indicate corresponding parts throughout the several views. The exemplifications set out herein illustrate one preferred embodiment of the invention, in one form, and such exemplifications are not to be construed as limiting the scope of the invention in any manner.

### DESCRIPTION OF THE PREFERRED EMBODIMENTS

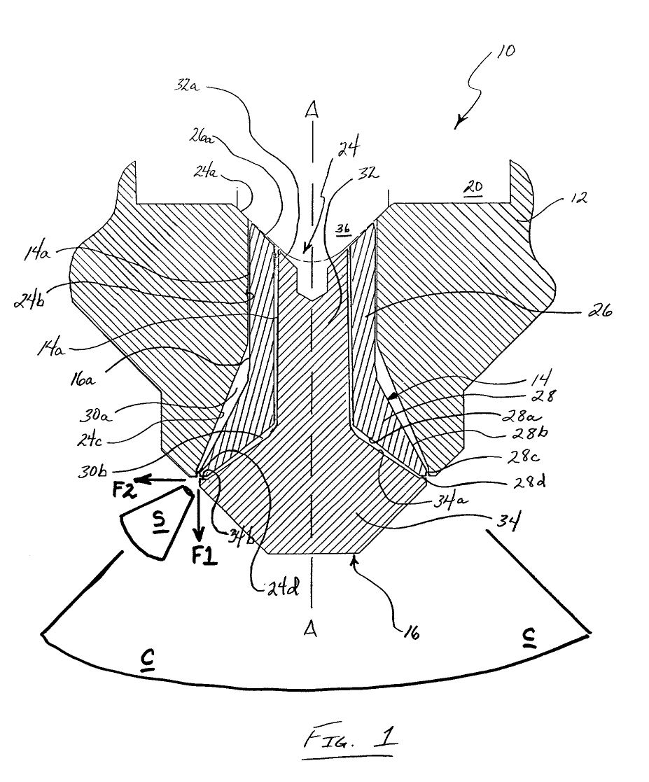

Referring now to the drawings and particularly to FIG. 1, there is shown one embodiment of an atomizer of the present invention. Atomizer 10 is configured for attachment to a source of pressurized fluid, and includes body 12, separator collar 14 and pintle 16.

Body 12 is substantially cylindrical in shape having central axis A. Body 12, such as, for example the injector seat of a fuel injector, defines central chamber 20. Central chamber 20 is at one end in fluid communication with a fluid source (not shown), such as, for example, the metering mechanism and/or valve of a fuel injector, which supplies fluid to be atomized. Central chamber 20 is at the other end thereof in fluid communication with connecting passage 24, which extends axially from central cavity 20 in the direction away from the fluid source.

Connecting passage 24 has a frustoconical-shaped top portion 24a that angles or tapers inward toward central axis A in a direction away from central chamber 20, i.e., the diameter of top portion 24a decreases in a direction away from central chamber 20. Connecting passage 24 further includes a cylindrical mid-portion 24b and a lower frustoconical-shaped bottom portion 24c that is terminated with a substantially cylindrical rim portion 24d. Rim portion 24d is substantially parallel with central axis A.

Separator collar 14 is a generally-cylindrical member that is received substantially concentrically within passage 24. Separator collar 14 includes first portion 26, which is substantially cylindrical in shape, and second portion 28. First portion 26 includes top end surface 26a, which is beveled or angled to match the angle of top portion 24a of connecting passage 24. With separator collar 14 operably disposed within connecting passage 24, top end surface 26a of separator collar 14 and top portion 24a of connecting passage 24 each taper substantially concentrically toward a smaller diameter in a direction away from central chamber 20. Separator collar 14 defines on the outer surface thereof flats 14a, such as, for example, machined flats, which are disposed along the axial length of the outer surface of first portion 26 of separator collar 14 from top end surface 26a to second portion 28. Flats 14a are of a predetermined width oriented generally in the direction perpendicular to axis A.

Second portion 28 is generally frustoconical in shape, and tapers outward relative to axis A (i.e., toward a wider diameter) in a direction away from first portion 26. More particularly, second portion 28 includes an inside surface 28a and an outside surface 28b, each of which taper outward relative to axis A toward a wider diameter in a direction away from first portion 26 of separator collar 14. Inside surface 28a tapers outward relative to axis A and in a direction away from first portion 26 at a greater rate than does outside surface 28b, such that inside surface 28a and outside surface 28b approach each other. First directing surface 28c is formed on outside surface 28b, and is substantially parallel relative to central axis A. Second directing surface 28d is formed on inside surface 28a, and is substantially perpendicular relative to central axis A. The intersection of first and second directing surfaces 28c, 28d is not radiused. Rather, the intersection of first and second directing surfaces 28c, 28d is a substantially perpendicular and sharp corner.

Pintle 16 includes neck portion 32 and head portion 34. Neck portion 32 is received substantially concentrically within separator collar 14. Neck portion 32 is substantially cylindrical, and includes end surface 32a that defines a recessed cone. End surface 32a is tapered toward a smaller diameter in a direction toward head portion 34. With neck portion 32 operably disposed within separator collar 14, top portion 24a of connection passage 24, top end surface 26a of separator collar 14 and frustoconical end surface 32a of pintle 16 each taper substantially concentrically toward a smaller diameter in a direction toward head portion 34, and thus form a conical chamber 36 that is substantially concentric relative to central axis A. Head portion 34 of pintle 16 includes an upper inside surface 34a that tapers toward a wider diameter (i.e., increases in diameter) in a direction away from neck portion 32, and a substantially cylindrical ledge portion 34b. Ledge portion 34b is substantially perpendicular to central axis A. Pintle 16 further defines flats 16a disposed on the outside surface thereof and axially along neck portion 32 from end surface 32a to head portion 34. Flats 16a are of a predetermined width that is oriented perpendicularly relative to axis A.

As stated above, separator collar 14 is received substantially concentrically within passage 24, and pintle 16 is received substantially concentrically within separator collar 14. Outer fluid passageway 30a is defined between the inside surface (i.e., mid and bottom portions 24b, 24c and 24d) of connecting passage 24 and each of flats 14a of separator collar 14, outside surface 28b and first directing surface 28c of second portion 28. Inner fluid passageway 30b is defined between the inside surface (not referenced) of separator collar 14 and flats 16a of pintle 16, and between inside surface 34a and ledge 34b of head portion 34 and inside surface 28a and second directing surface 28d of second portion 28.

In use, pressurized fluid, such as, for example, fuel or other fluid, flows into central chamber 20 and into chamber 36. Sufficient atomization is obtained by atomizer 10 at a fluid pressure of approximately equal to or greater than 2.0 Mpa. The fluid enters, and is separated into two separate and distinct flow paths by, outer fluid passageway 30a and inner fluid passageway 30b. Flow F1 exits outer fluid passageway 30a, and flow F2 exits inner fluid passageway 30b. As flow F1 exits outer fluid passageway 30a, it must flow through the relatively narrow clearance defined between first directing surface 28c and rim portion 24d, each of which are substantially parallel relative to central axis A. First directing surface 28c and rim portion 24d conjunctively direct flow F1 of exiting fluid in a direction that is substantially parallel with central axis A. As flow F2 exits inner fluid passageway 30b, it must flow through the relatively narrow clearance defined between second directing surface 28d and ledge 34b, which is substantially perpendicular relative to central axis A. Second directing surface 28d and ledge 34b are each substantially perpendicular relative to central axis A, and direct flow F2 of exiting fluid in a direction that is substantially perpendicular relative to central axis A. Thus, flows F1 and F2 are substantially perpendicular relative to each other as they exit atomizer 10. Flows F1 and F2 impinge upon each other external to atomizer 10.

The fluid momentum carried by substantially perpendicular impinging flows F1 and F2 substantially increases fluid shear of the fluid carried by flows F1 and F2, which, in turn, substantially increases the degree to which the fluid is atomized. Thus, the efficiency with which the fluid is atomized is also increased. The impingement of flows F1 and F2 create the edge of spray cone S, the geometry of which is determined by the ratio of the vertical flow component, i.e., F1, to the horizontal flow component, i.e., F2, which, in turn, are determined by the configuration of outer and inner fluid passageways 30a, 30b, respectively. The edge of spray cone S, in turn, defines conical spray cone C, which is a function of the ratio of F1 to F2.

Atomizer 10, and more particularly the exit points of outer and inner fluid passageways 30a, 30b, respectively, are configured to shape flows F1 and F2 into generally-circular sheets of exiting fluid, rather than round jets or streams of fluid. Further, impingement of flows F1 and F2 occurs externally, rather than internally, of atomizer 10. Atomization, or the break-up of sheet flows F1 and F2, occurs due to the collision and break-apart of the substantially-perpendicular flows F1 and F2. Outer and inner fluid passageways 30a, 30b, respectively, are of a predetermined configuration and dimensioned to produce a predetermined cone angle of conical spray cone C and a predetermined flow rate, and to produce a predetermined momentum exchange between flows F1 and F2 to ensure a desired level of atomization.

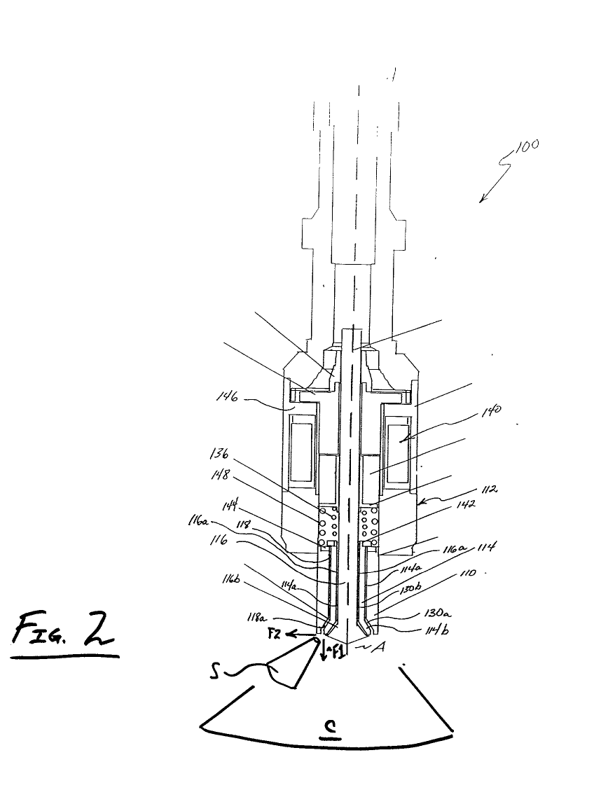

Referring now to FIG. 2, there is shown one embodiment of a fuel injector of the present invention. Fuel injector 100 has central axis A and includes lower housing 110, body 112, separator collar 114 and pintle 116. Lower housing 110, separator collar 114 and pintle 116 conjunctively define an atomizer (not referenced), which atomizes fluid in a manner that is substantially similar to the manner in which atomizer 10, as shown in FIG. 1 and described above, does so.

Lower housing 110 is attached, such as, for example, by welding, or otherwise coupled to body 112, and is substantially concentric with central axis A thereof. Lower housing 110 defines central bore 118 having an flared end 118a.

Separator collar 114 is received substantially concentrically within central bore 118. Separator collar 114 defines flats 114a, such as, for example, machined flats, on an outside surface thereof. Separator collar 114 includes a flared end 114b. The angle at which flared end 118a of central bore 118 flares out in a direction away from central axis A is closely matched, i.e., within from approximately 0.5 degrees to approximately 2 degrees, to the angle at which flared end 114b is angled outward in the same direction. The end (not referenced) of separator collar 114 that is opposite flared end 114b is engaged by spring 136. Outer fluid passageway 130a is defined between the inside surface (not referenced) of central bore 118 and the outside surface of separator collar 114. More particularly, outer fluid passageway 130a is defined between each of flats 114a and the outside surface of flanged end 114b of separator collar 114.

Pintle 116 is disposed substantially concentrically within separator collar 114. Pintle 116 defines flats 116a, such as, for example, machined flats, on the outside surface thereof. Pintle 116 includes flanged end 116b. The angle at which flanged end 116b of pintle 116 flares out in a direction away from central axis A is closely matched, i.e., within from approximately 0.5 degrees to approximately 2 degrees, to the angle at which flanged end 114b of separator collar 114 is angled outward in the same direction. The end (not referenced) of pintle 116 disposed opposite flanged end 116b is attached or otherwise associated with an armature/coil assembly 140. Inner fluid passageway 130b is defined between the outside surface of pintle 116 and the inside surface of separator collar 114. More particularly, inner fluid passageway 130b is defined between the inside surface (not referenced) of separator collar 114 and each of flats 116a and flanged end 116b of pintle 116.

In use, fuel injector 100 is connected to a source of pressurized fuel to be injected and to a source of electrical power in a known manner. The fuel is pressurized approximately 2.0 Mpa or greater. In the static state, i.e., when armature/coil assembly 140 is not energized, the outside surface (not referenced) of flanged end 116b of pintle 116 sealingly engages the inside surface (not referenced) of flanged end 114b of separator collar 114. Similarly, and also in the static state, the outside surface (not referenced) of flanged end 114b of separator collar 114 sealingly engages the inside surface (not referenced) of flared end 118a of central bore 118 of housing 110. Thus, both of outer and inner fluid passageways 30a and 30b are sealed, thereby preventing the flow of fluid therethrough.

The energizing of armature/coil assembly 140 displaces pintle 116 axially such that flanged end 116b moves in a direction away from separator collar 114 and away from housing 110, thereby unsealing inner fluid passageway 130b. Spring 136 biases separator collar 114 axially such that flanged end 114b thereof moves in a direction away from flared end 118a of cavity 118 and away from housing 110, thereby unsealing outer fluid passageway 130a. Thus, pressurized fluid flows through each of outer and inner fluid passageways 130a, 130b, and exits injector 100. Travel of separator collar 114 is limited by ring 142, which is associated with, such as, for example, pressed onto, separator collar 114, and engages stop surface 144. Stop surface 144 is associated with, such as, for example, pressed into, housing 110. Travel of pintle 116 is limited by stop 146 of armature/coil assembly 140. The travel of pintle 116 is a predetermined amount greater than the travel of separator collar 114.

Armature/coil assembly 140 is then de-energized, and spring 148 biases pintle 116 into sealing engagement with separator collar 114 which, in turn, is displaced axially toward housing 110 and into sealing engagement therewith. More particularly, pintle 116 is biased axially upward such that the outer surface of flanged end 116b thereof sealingly engages the inner surface of flanged end 114b of separator collar 114. The axial displacement of pintle 116, in turn, causes separator collar 114 axially into engagement with housing 110, such that the outside surface of flanged end 114b of separator collar 114 sealingly engages the inside surface of flared end 118a of central bore 118. Thus, sealing both of outer and inner fluid passageways 30a and 30b, and thereby preventing the flow of fluid therethrough.

During injection, i.e., when armature/coil assembly 140 is energized, fuel exits outer and inner fluid passageways 130a, 130b, respectively, substantially as described above in regard to atomizer 10. Further, the fuel exiting outer and inner fluid passageways 130a, 130b, respectively, is atomized in substantially the same manner as described above in regard to atomizer 10. More particularly, fluid enters and is separated into two separate and distinct flow paths by outer fluid passageway 130a and inner fluid passageway 130b. Flow F1 exits outer fluid passageway 130a, and flow F2 exits inner fluid passageway 130b. Outer fluid passageway 130a directs flow F1 in a direction that is substantially parallel relative to central axis A. Inner fluid passageway 130b directs flow F2 of exiting fluid in a direction that is substantially perpendicular to central axis A. Thus, flows F1 and F2 are substantially perpendicular relative to each other as they injector 100. Flows F1 and F2 impinge upon each other and fluid is atomized external to injector 100.

Fuel injector 100, and more particularly the exit points of outer and inner fluid passageways 130a, 130b, respectively, are configured to shape flows F1 and F2 into generally-circular sheets of exiting fluid, rather than round jets or streams of fluid. Further, impingement of flows F1 and F2 occurs externally, rather than internally, of fuel injector 100. Atomization, or the break-up of sheet flows F1 and F2, occurs due to the collision and break-apart of the substantially-perpendicular flows F1 and F2. Outer and inner fluid passageways 30a, 30b, respectively, are of a predetermined configuration and dimensioned to produce a predetermined cone angle of conical spray cone C and a predetermined flow rate, and to produce a predetermined momentum exchange between flows F1 and F2 to ensure a desired level of atomization.

In the embodiment shown, rim portion 24d is substantially parallel with central axis A. However, it is to be understood that rim portion 24d can be alternately configured, such as, for example, at a predetermined acute or obtuse angle relative to central axis A to thereby obtain a desired geometry of spray cone S.

In the embodiment shown ledge portion 34b is substantially perpendicular to central axis A. However, it is to be understood that ledge portion 34b can be alternately configured, such as, for example, at a predetermined acute or obtuse angle relative to central axis A to thereby obtain a desired geometry of spray cone S.

In the embodiment shown, separator collar 14, top portion 24a of passage 24, and frustoconical end surface 32a of pintle 16 for conical chamber 36. However, it is to be understood that separator collar 14, top portion 24a of passage 24, and frustoconical end surface 32a of pintle 16 can be alternately configured to form a chamber of a different geometry, such as, for example, frustoconical or stepped.

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

What is claimed:

1. A pressure atomizer, comprising:
a body having a central axis and defining a chamber, said body further defining a connecting passage, said connecting passage fluidly connecting said chamber to an exterior of said body, said connecting passage having an inside surface;
a substantially cylindrical separator collar disposed substantially concentrically within said connecting passage, said separator collar having an inside surface and an outside surface, at least a portion of said outside surface disposed a predetermined distance from said inside surface of said connecting passage to thereby define an outer fluid passageway, said outer fluid passageway extending from said chamber to a first exit point; and
a pintle disposed substantially concentrically within said separator collar, said pintle having an outside surface, at least a portion of said outside surface being disposed a predetermined distance from said inside surface of said separator collar to thereby define an inner fluid passageway, said inner fluid passageway extending from said chamber to a second exit point.

2. The pressure atomizer of claim 1, wherein said outer fluid passageway includes means to direct a flow of fluid exiting therefrom in a direction that is substantially parallel to said central axis.

3. The pressure atomizer of claim 2, wherein said means to direct comprises:
a substantially cylindrical rim, said rim being substantially parallel relative to said central axis, said rim defined by said inside surface of said connecting passage adjacent said first exit point; and
a first directing surface, said first directing surface being substantially parallel relative to said central axis, said first directing surface defined by said outside surface of said pintle adjacent said first exit point and being opposite said rim.

4. The pressure atomizer of claim 1, wherein said inner fluid passageway includes means to direct a flow of fluid exiting therefrom in a direction that is substantially perpendicular to said central axis.

5. The pressure atomizer of claim 4, wherein said means to direct comprises:
a substantially cylindrical ledge, said ledge being substantially perpendicular relative to said central axis, said ledge defined by said inside surface of said pintle adjacent said first exit point.; and
a second directing surface, said second directing surface being substantially perpendicular relative to said central axis, said second directing surface defined by said inside surface of said pintle adjacent said first exit point and being opposite said ledge.

6. The pressure atomizer of claim 1, wherein said outer fluid passageway includes a means to direct a flow of fluid exiting therefrom in a direction that is substantially parallel to said central axis, and said inner fluid passageway includes means to direct a flow of fluid exiting therefrom in a direction that is substantially perpendicular to said central axis.

7. The pressure atomizer of claim 6, wherein:
said means to direct of said outer fluid passageway comprises:
a substantially cylindrical rim, said rim being substantially parallel relative to said central axis, said rim defined by said inside surface of said connecting passage adjacent said first exit point; and
a first directing surface, said first directing surface being substantially parallel relative to said central axis, said first directing surface defined by said outside surface of said pintle adjacent said first exit point and being opposite said rim; and
said means to direct of said inner fluid passageway comprises:
a substantially cylindrical ledge, said ledge being substantially perpendicular relative to said central axis, said ledge defined by said inside surface of said pintle adjacent said first exit point; and
a second directing surface, said second directing surface being substantially perpendicular relative to said central axis, said second directing surface defined by said inside surface of said pintle adjacent said first exit point and being opposite said ledge.

8. The pressure atomizer of claim 1, wherein said connecting passage includes a substantially cylindrical top portion disposed adjacent said chamber, and a frustoconical bottom portion extending axially from said top portion in a direction away from said chamber and increasing in diameter in a direction away from said chamber.

9. The pressure atomizer of claim 8, wherein said separator collar includes a substantially cylindrical top portion disposed at least partially within said top portion of said connecting passage, and a frusto-conical bottom portion disposed within said bottom portion of said connecting passage.

10. The pressure atomizer of claim 9, wherein said top portion of said separator collar defines at least one flat on an outside surface thereof, said at least one flat defining a predetermined axial clearance between said outside surface of said top portion of said separator collar and an inside surface of said top portion of said connecting passageway to thereby define at least a portion of said outer fluid passageway.

11. The pressure atomizer of claim 9, wherein said bottom portion of said separator collar and said bottom portion of said connecting passage define a predetermined clearance therebetween to thereby define at least a portion of said outer fluid passageway.

12. The pressure atomizer of claim 9, wherein said pintle includes a substantially cylindrical stud portion disposed at least partially within said top portion of said separator collar, and a head portion disposed at least partially within said bottom portion of said separator collar.

13. The pressure atomizer of claim 12, wherein said stud portion of said pintle defines at least one flat on an outside surface thereof, said at least one flat defining a predetermined axial clearance between said outside surface of said stud portion and an inside surface of said top portion of said separator collar to thereby define at least a portion of said inner fluid passageway.

14. The pressure atomizer of claim 12, wherein said head portion of said pintle and an inside surface of said bottom portion of said separator collar define a predetermined clearance therebetween to thereby define at least a portion of said inner fluid passageway.

15. A fuel injector comprising:
a body having a central axis;
a lower housing affixed to said body, said lower housing defining a central cavity, said central cavity having an inside surface;
a separator collar disposed substantially concentrically within said lower housing, said separator collar having an inside and an outside surface, a predetermined clearance defined between said outside surface of said separator collar and said inside surface of said central cavity to thereby define an outer fluid passageway;
a pintle disposed at least partially within said separator collar and being substantially concentric therewith, said pintle having an outside surface, a predetermined clearance defined between said outside surface of said pintle and said inside surface of said separator collar to thereby define an inner fluid passageway; and
an armature and coil assembly operably associated with said pintle for reciprocating said pintle and thereby selectively sealing and unsealing said inner and outer fluid passageways.

16. The fuel injector of claim 15, wherein said outer fluid passageway includes means to direct a flow of fluid therethrough in a direction that is substantially parallel to said central axis.

17. The fuel injector of claim 16, wherein said means to direct comprises a flanged end of said separator collar and a flared end of said inside surface of said cavity.

18. The fuel injector of claim 15, wherein said inner fluid passageway includes means to direct a flow of fluid therethrough in a direction that is substantially perpendicular to said central axis.

19. The fuel injector of claim 18, wherein said means to direct comprises a flanged end of said pintle.

20. A method of atomizing fluid externally of a nozzle, comprising:
supplying a first and second fluid passageway of the nozzle with a flow of pressurized fluid;
directing the exit of the flow of pressurized fluid from said first fluid passageway in a first direction to thereby discharge from the nozzle a first sheet of fluid in said first direction; and
directing the exit of the flow of pressurized fluid from said second fluid passageway in a second direction, said second direction being substantially perpendicular to said first direction, to thereby discharge from the nozzle a second sheet of fluid in said second direction; and
impinging said first and second sheets of fluid upon each other external to the nozzle.
